(19) United States
(12) Patent Application Publication
(10) Pub. No.: US 2017/0142723 A1
(43) Pub. Date: May 18, 2017

(54) PROCESSOR AND MOBILE TERMINAL SUPPORTING CARRIER AGGREGATION

(71) Applicants: LE HOLDINGS (BEIJING) CO., LTD., Beijing (CN); Lemobile Information Technology (Beijing) Co., Ltd., Beijing (CN)

(72) Inventors: Wei LI, Beijing (CN); Niantao WANG, Beijing (CN)

(21) Appl. No.: 15/247,726

(22) Filed: Aug. 25, 2016

Related U.S. Application Data
(63) Continuation of application No. PCT/CN2016/087608, filed on Jun. 29, 2016.

(30) Foreign Application Priority Data
Nov. 13, 2015 (CN) 201510781129.5

(51) Int. Cl. H04W 72/04; H04W 76/02; H01Q 1/24

(52) U.S. Cl. CPC H04W 72/0453; H01Q 1/243; H04W 76/026

(57) ABSTRACT

The embodiment of the present disclosure discloses a processor and a mobile terminal supporting carrier aggregation. The processor supporting carrier aggregation comprises a signal receiving module, a radio frequency switch module as well as a waveband selecting module, wherein the signal receiving module is used for receiving a communication signal; the waveband selecting module is used for extracting and outputting signals of high frequency, intermediate frequency and low frequency to the radio frequency switch module respectively; the radio frequency switch module is used for accessing to a high frequency pathway, an intermediate frequency pathway and a low frequency pathway respectively. By adopting the processor and the mobile terminal supporting carrier aggregation, the effects that the layout area is reduced and the antenna design difficulty is relieved are achieved.

### CROSS-REFERENCE TO RELATED APPLICATIONS

The present disclosure is a continuation of International Application No. PCT/CN2016/087608 tiled on Jun. 29, 2016, which is based upon and claims priority to Chinese Patent Application No. 201510781129.5, entitled “PROCESSOR AND MOBILE TERMINAL SUPPORTING CARRIER AGGREGATION”, filed on Nov. 13, 2015, the entire contents of all of which are incorporated herein by reference.

### FIELD OF TECHNOLOGY

The present disclosure generally relates to the technical field of carrier aggregation, and in particular to a processor and a mobile terminal supporting carrier aggregation.

### BACKGROUND

At present, mobile terminals such as a mobile phone are developed in the tendency of multifunction, miniaturization, low radiation and low consumption. To meet the requirements of single user peak rate and system capacity increase, a most direct method is to increase the transmission bandwidth of a system. Therefore, a technology for increasing the transmission bandwidth, that is, CA (Carrier Aggregation) is introduced into an LTE-Advanced (follow-up evolution of LIE technology) system. Because of different LTE spectrum allocations, operators in different regions of the world have different carrier aggregation frequency band combination requirements, e.g. Inter-band CA and Intra-band CA.

In a conventional Inter-band CA achieving scheme, generally two antennas are adopted to achieve a high frequency band and an intermediate-low frequency band, similarly, two high frequency band and intermediate-low frequency band antennas are needed to achieve diversity antennas, so that four antennas are requested in all to achieve CA requirements of different frequency bands in a mobile phone. However, because of the four antennas, not only is the layout area increased, but also the antenna design difficulty is enhanced. The difficulty in placing the four antennas in appropriate positions in the mobile phone to reduce mutual interference of the antennas is also enhanced.

Therefore, how to achieve a processor and a mobile terminal supporting carrier aggregation to reduce the layout area and relieve the antenna design difficulty becomes a technical problem needing to be solved urgently.

### SUMMARY

The embodiment of the present disclosure discloses a processor and a mobile terminal supporting carrier aggregation, and aims to solve the defect that in the prior art too many antennas are adopted to achieve carrier aggregation, and to optimize antenna design and reduce layout area.

To solve the problems above, the embodiment of the present disclosure discloses a processor supporting carrier aggregation, including a signal receiving module, a radio frequency switch module as well as a waveband selecting module, wherein

the signal receiving module is used for receiving a communication signal;
the waveband selecting module is used for extracting and outputting signals of high frequency, intermediate frequency and low frequency to the radio frequency switch module respectively;
the radio frequency switch module is used for accessing to a high frequency pathway, an intermediate frequency pathway and a low frequency pathway respectively.

Furthermore, the signal receiving module in the processor of the present disclosure includes an antenna.

Furthermore, the waveband selecting module in the processor of the present disclosure includes a triplexer.

Furthermore, the waveband selecting module in the processor of the present disclosure includes two duplexers.

Furthermore, the radio frequency switch module in the processor of the present disclosure includes:

a high frequency switch group for conducting a high frequency signal received from the waveband selecting module and accessing to a high frequency pathway;
an intermediate frequency switch group for conducting an intermediate frequency signal received from the waveband selecting module and accessing to an intermediate frequency pathway;
a low frequency switch group for conducting a low frequency signal received from the waveband selecting module and accessing to a low frequency pathway.

The embodiment of the present disclosure further discloses a mobile terminal supporting carrier aggregation, including a signal receiving module, a radio frequency switch module as well as a waveband selecting module, wherein

the signal receiving module is used for receiving a communication signal;
the waveband selecting module is used for extracting and outputting signals of high frequency, intermediate frequency and low frequency to the radio frequency switch module respectively;
the radio frequency switch module is used for accessing to a high frequency pathway, an intermediate frequency pathway and a low frequency pathway respectively.

Furthermore, the signal receiving module in the mobile terminal of the present disclosure includes an antenna.

Furthermore, the waveband selecting module in the mobile terminal of the present disclosure is a triplexer.

Furthermore, the waveband selecting module in the mobile terminal of the present disclosure refers to two duplexers.

Furthermore, the radio frequency switch module in the mobile terminal of the present disclosure includes;

a high frequency switch group for conducting a high frequency signal received from the waveband selecting module and accessing to a high frequency pathway;
an intermediate frequency switch group for conducting an intermediate frequency signal received from the waveband selecting module and accessing to an intermediate frequency pathway;
a low frequency switch group for conducting a low frequency signal received from the waveband selecting module and accessing to a low frequency pathway.

According to the processor and the mobile terminal supporting carrier aggregation in the embodiment of the present disclosure, the waveband selecting module extracts signals of different wavebands from the communication signal received by the signal receiving module and outputs the signals to different radio frequency switch groups so as to achieve carrier aggregation of different frequency bands, so that the effects of reducing the layout area and relieving the antenna design difficulty are achieved.

### BRIEF DESCRIPTION OF THE DRAWINGS

To clearly describe the technical schemes in, the embodiments of the present disclosure or in the prior art, figures needing to be used in the description of the embodiments or the prior art are briefly introduced as follows, obviously, the figures described below are some embodiments of the present disclosure, and for common technicians of the field, other figures can be also obtained according to the figures under the condition that no creative work is made.

FIG. 1 shows the structure block diagram of the processor supporting carrier aggregation in the embodiment of the present disclosure.

FIG. 2 shows the structure block diagram of the mobile terminal supporting carrier aggregation in the embodiment of the present disclosure.

FIG. 3 shows the structure block diagram of the mobile terminal supporting carrier aggregation in another embodiment of the present disclosure.

### DESCRIPTION OF THE EMBODIMENTS

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by common technicians of the field under the condition that no creative work is made all belong to the protection scope of the present disclosure.

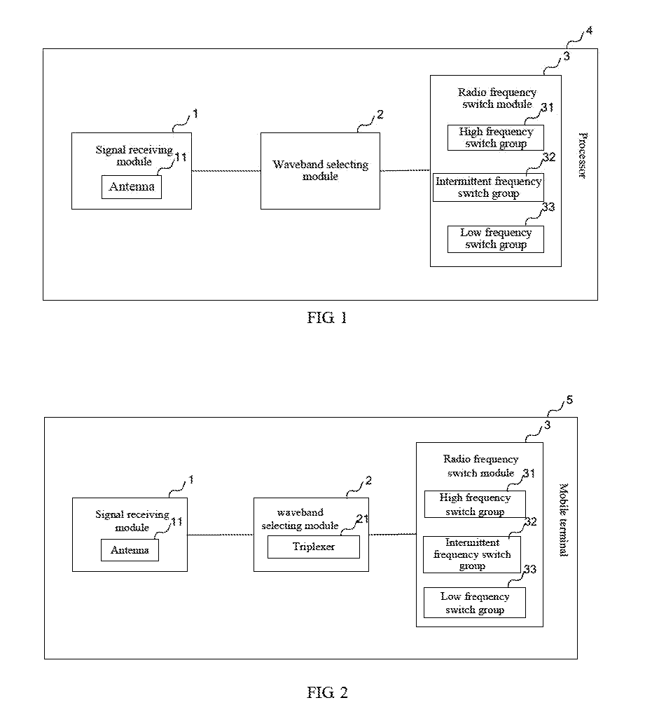

FIG. 1 shows the structure block diagram of the processor supporting carrier aggregation in the embodiment of the present disclosure.

The processor 4 of the embodiment includes:

a signal receiving module 1, for receiving the communication signal;
a waveband selecting module 2, for extracting and outputting signals of high frequency, intermediate frequency and low frequency to the radio frequency switch module respectively;
a radio frequency switch module 3, for accessing to the high frequency pathway, the intermediate frequency pathway and the low frequency pathway respectively.

According to the processor 4 in the embodiment, the signal receiving module 1 includes: the antenna 11. The waveband selecting module 2 can be the triplexer. The radio frequency switch module 3 includes the high frequency switch group 31, the intermediate frequency switch module 32 and the low frequency switch group 33.

The antenna 11 is used for receiving the communication signal. The triplexer is used for extracting signals of different wavebands from the received communication signal, such as the high frequency signal, the intermediate frequency signal and the low frequency signal, subsequently the signals of different wavebands are output to the radio frequency switch group, for example, the high frequency signal is output to the high frequency switch group 31, the intermediate frequency signal is output to the intermediate frequency switch group 32 and the low frequency signal is output to the low frequency switch group 33, then the high frequency pathway, the intermediate frequency pathway and the low frequency pathway can be accessed respectively.

Due to the embodiment, carrier aggregation of different frequency bands can be achieved, and the effects of reducing the layout area and relieving the antenna design difficulty can be achieved.

Two duplexers can be used in the waveband selecting module 2 in the processor 4 of the embodiment to extract and output signals of different wavebands to the radio frequency switch groups of different wavebands, for example, the waveband selecting module 2 includes a first duplexer 22 and a second duplexer 23. Similarly, carrier aggregation of different frequency bands is achieved, so that the effects of reducing the layout area and relieving the antenna design difficulty can be achieved.

FIG. 2 shows the structure block diagram of the mobile terminal supporting carrier aggregation in the embodiment of the present disclosure.

The mobile terminal 5 of the embodiment includes:

a signal receiving module 1, for receiving the communication signal;
a waveband selecting module 2, for extracting and outputting signals of high frequency, intermediate frequency and low frequency to the radio frequency switch module respectively;
a radio frequency switch module 3, for accessing to the high frequency pathway, the intermediate frequency pathway and the low frequency pathway respectively.

According to the mobile terminal 5 in the embodiment, the signal receiving module 1 includes: the antenna 11. The waveband selecting module 2 can be the triplexer 21. The radio frequency switch module 3 includes the high frequency switch group 31, the intermediate frequency switch module 32 and the low frequency switch group 33.

The antenna 11 is used for receiving the communication signal. The triplexer 21 is used for extracting signals of different wavebands from the received communication signal, such as the high frequency signal, the intermediate frequency signal and the low frequency signal, subsequently the signals of different wavebands are output to the radio frequency switch group, for example, the high frequency signal is output to the high frequency switch group 31, the intermediate frequency signal is output to the intermediate frequency switch group 32 and the low frequency signal is output to the low frequency switch group 33, then the high frequency pathway, the intermediate frequency pathway and the low frequency pathway can be accessed respectively.

Due to the embodiment, carrier aggregation of different frequency bands can be achieved, and the effects of reducing the layout area and relieving the antenna design difficulty can be achieved.

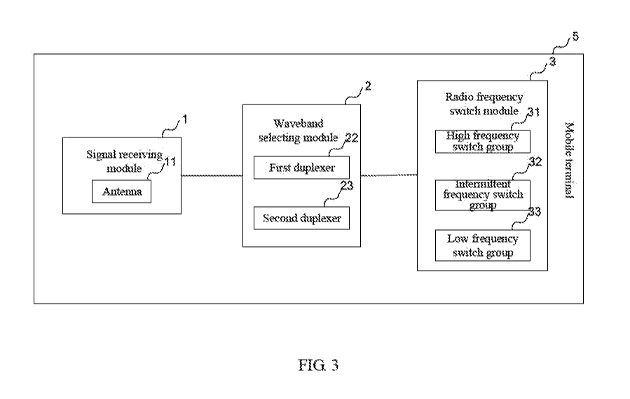

FIG. 3 shows the structure block diagram of the mobile terminal supporting carrier aggregation in another embodiment of the present disclosure.

Two duplexers can be used in the waveband selecting module 2 in the mobile terminal 5 of the embodiment to extract and output signals of different wavebands to the radio frequency switch groups of different wavebands, for example, a first duplexer 22 and a second duplexer 23. The achieving principle and the technical effect of the embodiment are similar to those of the embodiment as shown in FIG. 2, and are not explained here any longer.

Although optimal embodiments of the present disclosure are described, once understanding the basic creative concept, technicians of the field can change and modify the embodiments, so the claims can be interpreted as including, the optimal embodiments and all change and modification within the range of the embodiments of the present disclosure.

Finally, what needing to be explained is that in the present disclosure, relationship terms such as the first one and the second one are only to distinguish one entity or operation from another entity or operation, but not require or hint that the entities or operations are in any practical relationship or sequence. Moreover, the terms “include”, “include” or any other variant intend to cover non-exclusive inclusion, so that processes, methods, articles or terminal equipment including a series of elements include not only the elements, but also other elements which are not clearly listed, or include inherent elements of the processes, the methods, the articles or the terminal equipment. Under the condition of no more limit, elements defined by a sentences “includes a . . . ” do not exclude that the processes, the methods, the articles or the terminal equipment including the elements also include other similar elements.

The final description is that the embodiments are only used for describing the technical scheme of the present disclosure but not for limiting. Although the present disclosure is specifically described with reference to the embodiments, common technicians of the field shall understand that the technical scheme recorded by each of the embodiments can be modified, or one part of technical characteristics can be equivalently replaced; and the modification or replacement does not enable the essence of the corresponding technical scheme to get out of the spirit and scope of the technical scheme in each embodiment of the present disclosure.

What is claimed is:

1. A processor supporting carrier aggregation, comprising: a signal receiving module, a radio frequency switch module as well as a waveband selecting module, wherein
the signal receiving module is used for receiving a communication signal;
the waveband selecting module is used for extracting and outputting signals of high frequency, intermediate frequency and low frequency to the radio frequency switch module respectively;
the radio frequency switch module is used for accessing to a high frequency pathway, an intermediate frequency pathway and a low frequency pathway respectively.

2. The processor according to claim 1, wherein the signal receiving module comprises an antenna.

3. The processor according to claim 1, wherein the waveband selecting module comprises a triplexer.

4. The processor according to claim 1, wherein the waveband selecting module comprises two duplexers.

5. The processor according to claim 1, wherein the radio frequency switch comprises:
a high frequency switch group for conducting as high frequency signal received from the waveband selecting module and accessing to a high frequency pathway;
an intermediate frequency switch group for conducting an intermediate frequency signal received from the waveband selecting module and accessing to an intermediate frequency pathway;
a low frequency switch group for conducting a low frequency signal received from the waveband selecting module and accessing to a low frequency pathway.

6. A mobile terminal supporting carrier aggregation, comprising a signal receiving module, a radio frequency switch module as well as a waveband selecting module, wherein
the signal receiving module is used for receiving a communication signal:
the waveband selecting module is used for extracting and outputting signals of high frequency, intermediate frequency and low frequency to the radio frequency switch module respectively:
the radio frequency switch module is used for accessing to a high frequency pathway, an intermediate frequency pathway and a low frequency pathway respectively.

7. The mobile terminal according to claim 6, wherein the signal receiving module comprises an antenna.

8. The mobile terminal according to claim 6, wherein the waveband selecting module comprises a triplexer.

9. The mobile terminal according to claim 6, wherein the waveband selecting module comprises two duplexers.

10. The mobile terminal according to claim 6, wherein the radio frequency switch comprises:
a high frequency switch group for conducting a high frequency signal received from the waveband selecting module and accessing to a high frequency pathway;
an intermediate frequency switch group for conducting an intermediate frequency signal received from the waveband selecting module and accessing to an intermediate frequency pathway;
a low frequency switch group for conducting a low frequency signal received from the waveband selecting module and accessing to a low frequency pathway.
